(19) United States
(12) Patent Application Publication
(10) Pub. No.: US 2026/0108807 A1
(43) Pub. Date: Apr. 23, 2026

(54) SERVER DEVICE, INFORMATION PROCESSING DEVICE, AND EVENT INVITATION METHOD

(71) Applicant: Sony Interactive Entertainment Inc., Tokyo (JP)

(72) Inventor: Tatsuki Amimoto, Tokyo (JP)

(73) Assignee: Sony Interactive Entertainment Inc., Tokyo (JP)

(21) Appl. No.: 19/385,979

(22) Filed: Nov. 11, 2025

Related U.S. Application Data
(63) Continuation of application No. PCT/JP2023/022903, filed on Jun. 21, 2023.

(51) Int. Cl. A63F 13/35

(52) U.S. Cl. CPC A63F 13/35

(57) ABSTRACT

Systems and methods for organizing online events are disclosed. An example server includes one or more processors having hardware. The one or more processors acquire game start information indicating that a plurality of users have started a game, acquire game end information indicating that the plurality of users have ended the game, derive a probability that each of the plurality of users will play the game in a plurality of time periods in a future using the game start information and the game end information in a past of the plurality of users, identify a time period in the future in which there are many users having high probabilities of playing the game, and notify a user who will act as a host of information indicating the identified time period in the future and information on the users having high probabilities of playing the game in the time period.

### CROSS-REFERENCES TO RELATED APPLICATIONS

This application is a Continuation application under 35 U.S.C. § 111 of International Application No. PCT/JP2023/022903, filed Jun. 21, 2023, the entire disclosure of which are incorporated herein by reference for all purposes.

### TECHNICAL FIELD

The present disclosure relates to a technique for supporting of holding events such as game tournaments.

### BACKGROUND

The popularity of e-sports is growing worldwide, and currently, businesses that have received licenses from game publishers and developers are holding tournaments for a variety of games. A host determines the tournament details, such as the date and time of the event and the match format, and recruits participants, who then participate in the game tournament when the date and time of the event arrives.

### SUMMARY

In game tournaments, users compete against unspecified players, but the bar for competing against unknown players is high, and there is a desire to compete against friends.

Therefore, it is preferable that users themselves can act as hosts and hold game tournaments in which friends and other acquaintances can compete against each other. Therefore, an object of the present disclosure is to provide art for efficiently supporting the holding of events such as game tournaments in which users act as hosts.

A server device according to an aspect of the present disclosure is provided with one or more processors having hardware. The one or more processors acquire game start information indicating that a plurality of users have started a game, acquire game end information indicating that the plurality of users have ended the game, derive a probability that each of the plurality of users will play the game in a plurality of time periods in a future using the game start information in a past and the game end information in the past of the plurality of users, identify a time period in the future in which there are many users having high probabilities of playing the game, and notify a user who will act as a host of information indicating the identified time period in the future and information on the users having high probabilities of playing the game in the time period.

An information processing device according to another aspect of the present disclosure is provided with one or more processors having hardware. The one or more processors acquire information indicating a time period in a future and information on users having high probabilities of playing a game in the time period, display the acquired time period in the future and a number of the users having high probabilities of playing the game in the time period, and invite at least the users having high probabilities of playing the game to events to be held during the time period in the future.

Note that any combination of the above constituent elements, and conversion of an expression of the present disclosure into a method, device, system, recording medium, computer program, or the like are also valid aspects of the present disclosure.

### BRIEF DESCRIPTION OF THE DRAWINGS

FIG. 1 is a diagram illustrating an information processing system according to an embodiment.

FIG. 2 is a diagram illustrating a hardware configuration of an information processing device.

FIG. 3 is a diagram illustrating functional blocks of the information processing device.

FIG. 4 is a diagram illustrating functional blocks of a server device.

FIG. 5 is a diagram illustrating dates and times when a user played a game.

FIG. 6 is a diagram illustrating time periods when a user played a game.

FIG. 7 is a diagram illustrating play probabilities in a plurality of time periods in a future.

FIG. 8 is a diagram illustrating an example of a settings screen for a private tournament.

FIG. 9 is a diagram illustrating an example of a friend list.

FIG. 10 is a diagram illustrating an example of an advanced settings screen for a private tournament.

### DETAILED DESCRIPTION OF THE INVENTION

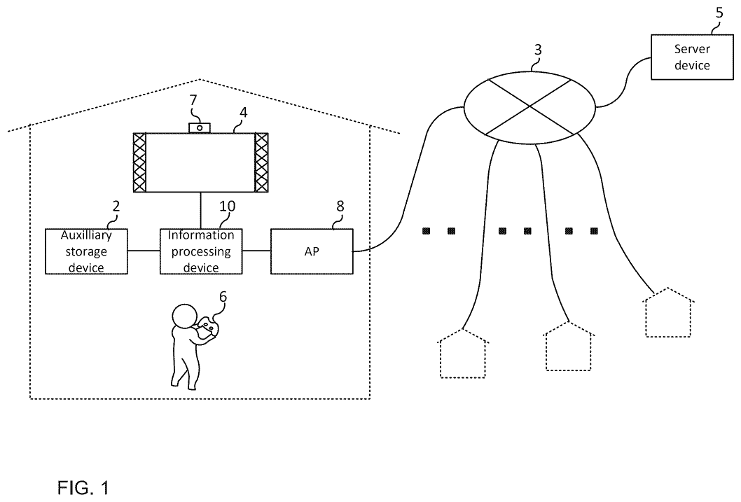

FIG. 1 illustrates an information processing system 1 according to an embodiment of the present disclosure. The information processing system 1 according to the embodiment is a game system that supports the holding of an event such as a game tournament, and is provided with an information processing device 10 that is operated by a user, and a server device 5. An access point (hereinafter referred to as “AP”) 8 has the functions of a wireless access point and a router, and the information processing device 10 connects to the AP 8 wirelessly or via a wired connection to communicably connect to the server device 5 on a network 3. While FIG. 1 illustrates one user and one information processing device 10, the information processing system 1 is premised on a plurality of the information processing apparatus 10 operated by a plurality of users being connected to the server device 5 via the network 3.

The information processing device 10 is connected wirelessly or via a wired connection to an input device 6 that is operated by a user, and the input device 6 outputs information operated by the user to the information processing device 10. When receiving operation information from the input device 6, the information processing device 10 reflects the information in system software and game software processing, and outputs the processing results from an output device 4. In the information processing system 1, the information processing device 10 is a game device (game console) that executes a game, and the input device 6 may be equipment such as a game controller that supplies user operation information to the information processing device 10. Note that the input device 6 may be an input interface such as a keyboard or a mouse.

An auxiliary storage device 2 is a large-capacity recording device such as an HDD (hard disk drive) or an SSD (solid state drive), and may be a built-in recording device or an external recording device that is connected to the information processing device 10 via a USB (universal serial bus) or the like. The output device 4 may be a television that has a display for outputting an image and a speaker for outputting sound. The output device 4 may be connected to the information processing device 10 by a wired cable, or may be connected wirelessly.

A camera 7 serving as an imaging device is provided in a vicinity of the output device 4 and captures an image of a space around the output device 4. Although FIG. 1 illustrates an example in which the camera 7 is mounted on a top portion of the output device 4, the camera 7 may be disposed on a side or bottom portion of the output device 4, and in any case, is disposed in a position in which an image of a user positioned in front of the output device 4 may be captured. The camera 7 may also be a stereo camera.

The server device 5 provides a network service to a user of the information processing system 1. The server device 5 manages network accounts (user accounts) that distinguish users, and the users sign in to the network service provided by the server device 5 by using the network accounts. By signing in to the network service from the information processing device 10, a user may register game save data and trophies, which are virtual prizes obtained during gameplay, in the server device 5. By registering the save data and the trophies in the server device 5, the save data and trophies may be synchronized even when the user uses an information processing device other than the information processing device 10.

The server device 5 according to the embodiment acquires information relating to the start and end of a game from a plurality of information processing devices 10. Specifically, the server device 5 acquires game start information indicating that a user has started the game, and game end information indicating that the user has ended the game. When starting a game, the information processing device 10 generates game start information including information for distinguishing the game (game ID) and information indicating the time when the game was started (timestamp), and transmits this information to the server device 5. Furthermore, when ending a game, the information processing device 10 generates game end information including information for distinguishing the game (game ID) and information indicating the time when the game was ended (timestamp), and transmits this information to the server device 5. The server device 5 is able to identify the time periods during which the user played the game by acquiring the game start information and the game end information.

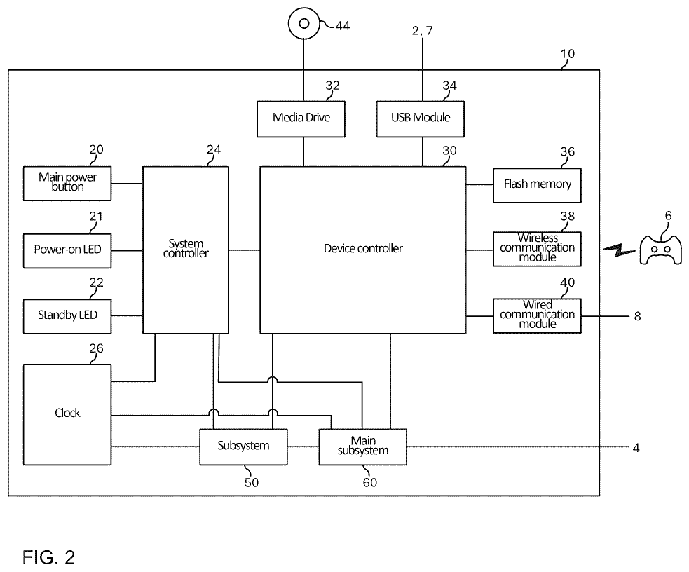

FIG. 2 illustrates a hardware configuration of the information processing device 10. The information processing device 10 is configured having a main power button 20, a power-on LED 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 is provided with a main CPU (central processing unit), a memory serving as a main storage device, a memory controller, a GPU (graphics processing unit), and the like. The GPU is primarily used for computational processing of a game program. The main CPU has the function of starting up the system software and executing a game program installed in the auxiliary storage device 2 in an environment provided by the system software. The subsystem 50 is provided with a sub-CPU, the memory serving as the main storage device, the memory controller, and the like, but is not provided with the GPU.

While the main CPU has the function of executing the game program installed in the auxiliary storage device 2, the sub-CPU does not have such a function. However, the sub-CPU has a function of accessing the auxiliary storage device 2 and a function of transmitting and receiving data to and from the server device 5. The sub-CPU is configured having only such limited processing functions, and may therefore operate with less power consumption than the main CPU. These functions of the sub-CPU are executed when the main CPU is in a standby state.

The main power button 20 is an input unit wherein operation input from a user is performed, is provided on a front surface of a housing of the information processing device 10, and is operated in order to turn on or turn off power supply to the main system 60 of the information processing device 10. The power-on LED 21 lights up when the main power button 20 is turned on, and the standby LED 22 lights up when the main power button 20 is turned off. The system controller 24 detects when the main power button 20 is pressed by a user.

The clock 26 is a real-time clock that generates current date and time information and supplies such to the system controller 24, the subsystem 50, and the main system 60.

The device controller 30 is configured as an LSI (large-scale integrated circuit) that executes a transfer of information between devices, like a southbridge. As illustrated in the figure, devices such as the system controller 24, the media drive 32, the USB module 34, the flash memory 36, the wireless communication module 38, the wired communication module 40, the subsystem 50, and the main system 60 are connected to the device controller 30. The device controller 30 absorbs a difference in electrical characteristics and a gap in data transfer speeds of the various devices and controls the timing of data transfer.

The media drive 32 is a drive device that is driven by loading a ROM medium 44 on which application software such as a game and license information are recorded, and that reads out programs, data, and the like from the ROM medium 44. The ROM medium 44 is a read-only recording medium such as an optical disk, a magneto-optical disk, or a Blu-ray disk.

The USB module 34 is a module that connects to external equipment using a USB cable. The USB module 34 may be connected to the auxiliary storage device 2 and the camera 7 via a USB cable. The flash memory 36 is an auxiliary storage device that constitutes internal storage. The wireless communication module 38 wirelessly communicates with the input device 6 using a communication protocol such as a Bluetooth (registered trademark) protocol or an IEEE 802.11 protocol. The wired communication module 40 performs wired communication with external equipment, and connects to the network 3 via the AP 8.

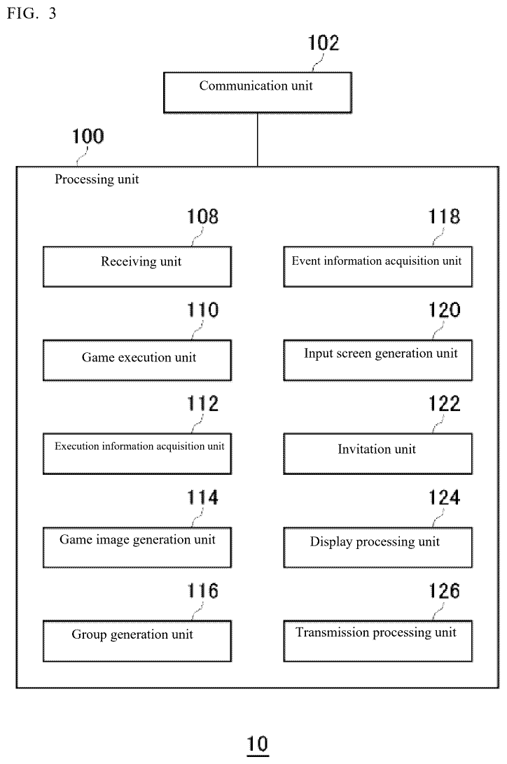

FIG. 3 illustrates functional blocks of the information processing device 10. The information processing device 10 is provided with a processing unit 100 and a communication unit 102. The processing unit 100 is provided with a receiving unit 108, a game execution unit 110, an execution information acquisition unit 112, a game image generation unit 114, a group generation unit 116, an event information acquisition unit 118, an input screen generation unit 120, an invitation unit 122, a display processing unit 124, and a transmission processing unit 126. The receiving unit 108 receives operation information of the user having operated the input device 6.

The information processing device 10 is provided with a computer, and the various functions illustrated in FIG. 3 are realized by the computer executing a program. The computer is provided with, as hardware, a memory into which the program is loaded, one or more processors that execute the loaded program, an auxiliary storage device, other LSIs, and the like. The processor is configured by a plurality of an electronic circuit including a semiconductor integrated circuit and an LSI, and the plurality of electronic circuits may be mounted on a single chip or may be mounted on a plurality of chips. The functional blocks illustrated in FIG. 3 are realized by cooperation of hardware and software, and therefore, it will be understood by those skilled in the art that these functional blocks may be realized in various forms by hardware alone, software alone, or a combination thereof.

The game execution unit 110 starts and executes the game program. When starting the game, the game execution unit 110 outputs game start information indicating that the game has been started to the execution information acquisition unit 112. The game start information includes information for distinguishing the game (game ID) and information indicating the time when the game was started (timestamp). The game start information may be generated by the system software, but may also be generated by the game program. When the execution information acquisition unit 112 acquires the game start information, the transmission processing unit 126 transmits the game start information to the server device 5.

When the game execution unit 110 starts the game program, the game program performs computational processing to move a game character in a virtual space based on the operation information received by the receiving unit 108. The game image generation unit 114 includes a GPU (graphics processing unit) that executes rendering processes and the like, and generates image data of the game, and the display processing unit 124 outputs the generated game image from the output device 4. Note that the processing unit 100 is provided with a game audio generation unit that generates game audio data, but illustration is omitted in FIG. 3.

When finishing the started game, the game execution unit 110 outputs game end information indicating that the game has ended to the execution information acquisition unit 112. The game end information includes information for distinguishing the game (game ID) and information indicating the time when the game was ended (timestamp). The game end information may be generated by the system software, but may also be generated by the game program. When the execution information acquisition unit 112 acquires the game end information, the transmission processing unit 126 transmits the game end information to the server device 5.

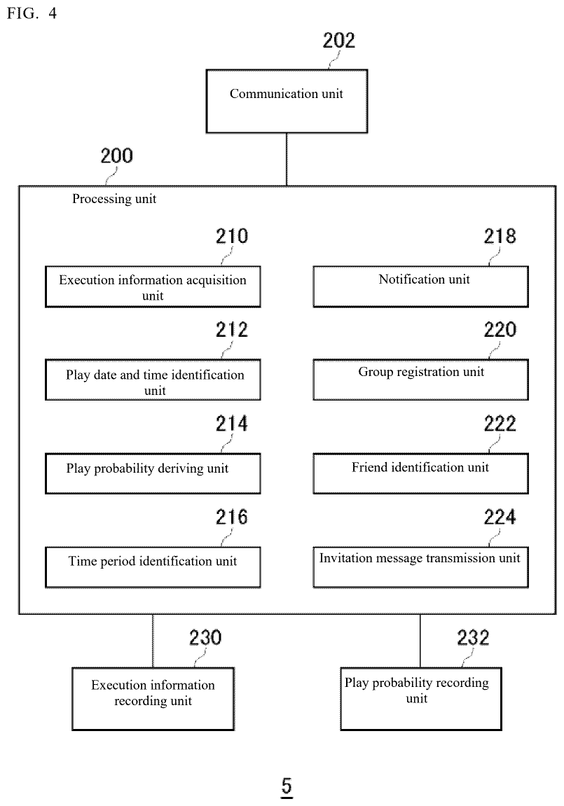

FIG. 4 illustrates functional blocks of the server device 5 according to the embodiment. The server device 5 is provided with a processing unit 200, a communication unit 202, an execution information recording unit 230, and a play probability recording unit 232. The processing unit 200 is provided with an execution information acquisition unit 210, a play date and time identification unit 212, a play probability derivation unit 214, a time period identification unit 216, a notification unit 218, a group registration unit 220, a friend identification unit 222, and an invitation message transmission unit 224.

The server device 5 is provided with a computer, and the various functions illustrated in FIG. 4 are realized by the computer executing a program. The computer is provided with, as hardware, a memory into which the program is loaded, one or more processors that execute the loaded program, an auxiliary storage device, other LSIs, and the like. The processor is configured by a plurality of an electronic circuit including a semiconductor integrated circuit and an LSI, and the plurality of electronic circuits may be mounted on a single chip or may be mounted on a plurality of chips. The functional blocks illustrated in FIG. 4 are realized by cooperation of hardware and software, and therefore, it will be understood by those skilled in the art that these functional blocks may be realized in various forms by hardware alone, software alone, or a combination thereof.

When acquiring game start information indicating that a plurality of users have started a game from a plurality of information processing devices 10, the execution information acquisition unit 210 records the game start information in the execution information recording unit 230 by linking such to the network accounts of the users. Furthermore, when acquiring game end information indicating that a plurality of users have ended a game from a plurality of information processing devices 10, the execution information acquisition unit 210 records the game end information in the execution information recording unit 230 by linking such to the network accounts of the users.

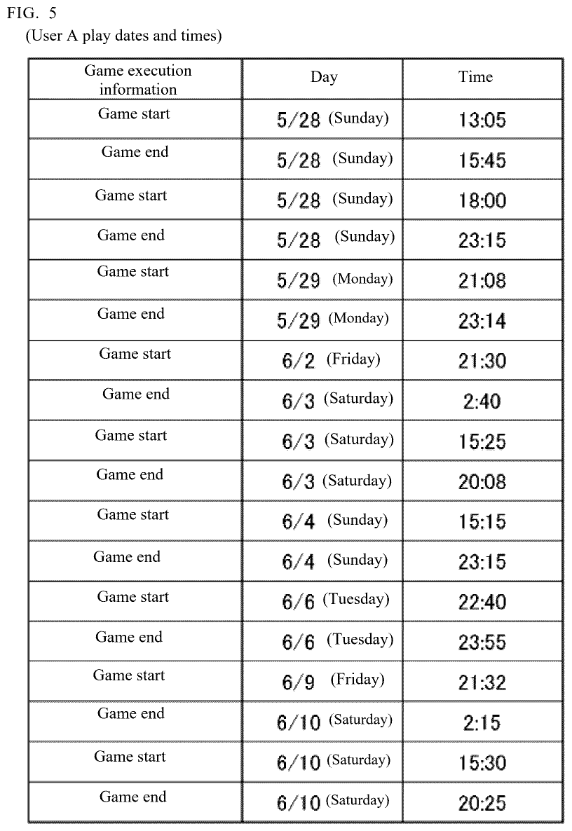

FIG. 5 illustrates dates and times when a user A played a game. FIG. 5 illustrates play dates and times for user A over the past two weeks. The play date and time identification unit 212 reads the game start information and the game end information of the user A recorded in the execution information recording unit 230, and identifies past play initiation dates and times and play end dates and times of user A. The play date and time identification unit 212 divides one day into three-hour slots and identifies slots (time periods) in which the user A played.

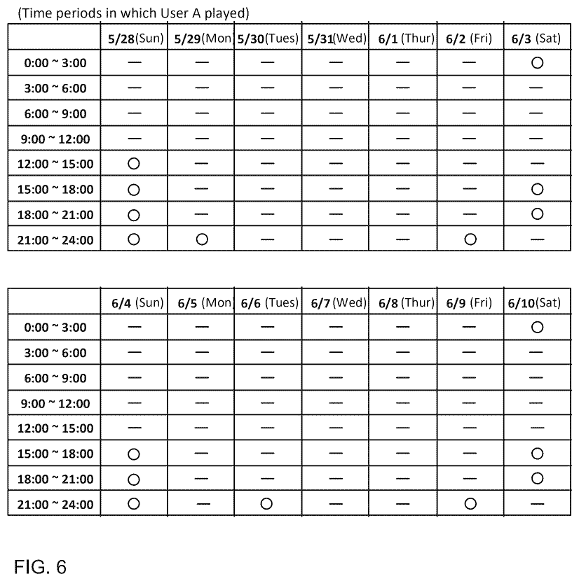

FIG. 6 illustrates time periods when the user A played the game. In FIG. 6, an “O” listed during a time period indicates that the user played during the time period, and a “-” indicates that the user did not play during the time period. The play date and time identification unit 212 identifies the time periods in which the user A played the game in the past based on the play dates and times illustrated in FIG. 5. Note that in the present example, the play date and time identification unit 212 refers to the play dates and times for the past two weeks, but it may also refer to the play dates and times for the past 10 weeks to identify the time periods in which the user A played the game during the past 10 weeks.

The play probability derivation unit 214 derives a probability that the user A will play the game in a plurality of time periods in a future. The play probability derivation unit 214 may derive play probabilities for a plurality of time periods in the future from past play dates and times through statistical processing.

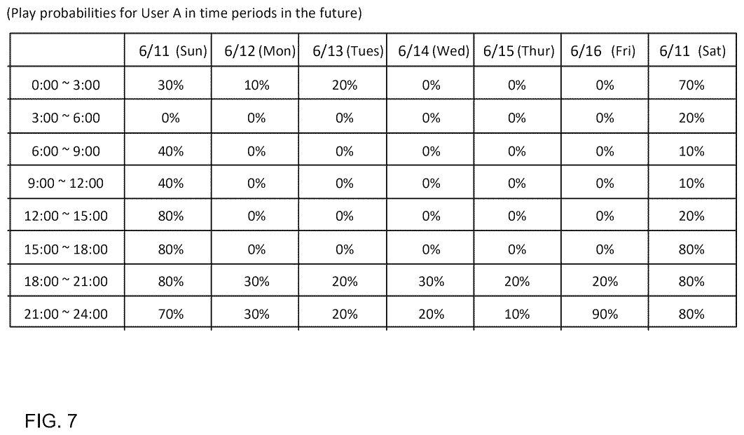

FIG. 7 is a diagram illustrating play probabilities in a plurality of time periods in the future for the user A. In the present example, the play probability derivation unit 214 derives the play probability for one week from Jun. 11 (Sunday) based on the time periods during which the user A played the game over the past 10 weeks. For example, the probability of playing between 12:00 and 15:00 on Jun. 11 (Sunday) is derived to be 80%. This means that the user A played the game on eight Sundays in the past 10 weeks between 12:00 and 15:00 (the play probability is derived to be 80% because the user A played on eight of the past 10 Sundays). In this manner, in the embodiment, the play probability derivation unit 214 may derive the future play probability from a past track record of playing during the same time period on the same day of the week.

The above is a method for deriving the play probability for the user A in a future time period, but the play probability derivation unit 214 derives the play probabilities in future time slots for all users who are signed in to the network service. The play probability derivation unit 214 derives the probability that each of the plurality of users will play the game in a plurality of time periods in the future, and records such in the play probability recording unit 232.

The time period identification unit 216 refers to the play probabilities for a plurality of time periods in the future recorded in the play probability recording unit 232 and identifies a time period in the future in which there are many users having high probabilities of playing the game. A user having a high play probability is a user exhibiting a play probability that is equal to or greater than a predetermined value (for example, 70%). Therefore, the time period identification unit 216 has a function of identifying the time period in the future in which there are many users exhibiting a play probability of 70% or more.

The server device 5 according to the embodiment provides an environment in which users are able to freely hold events such as game tournaments. The user who will act as the host (hereinafter also referred to as the “host user”) determines the details of the game tournament (for example, the title of the game to be played, the date and time of the event, and the like) and invites, for example, his or her friends to participate. At this time, when the host user decides the date and time of the event without knowing the availability of his or her friends, most of the friends may not be able to participate as a result, and the game tournament may not be a lively event. Therefore, the server device 5 is provided with a function of derivation time periods in which many friends are likely to participate based on the play probability of the friends in the time period in the future, and presenting such to the host user.

A case in which the user A is the host user is described hereinafter. When the user A opens a system menu list (not illustrated) and selects a menu item, “Generate a private tournament”, the information processing device 10 transmits a private tournament generation request to the server device 5. Note that the private tournament creation menu may be prepared by the game. In this case, the user A may start the game and select the “Generate a private tournament” menu item from a menu list within the game. When the server device 5 acquires the private tournament generation request, the friend identification unit 222 identifies a plurality of friends of the user A. The plurality of friends of the user A are registered in advance in the server device 5.

The play date and time identification unit 212 reads the game start information and the game end information of a plurality of friends of the user A recorded in the execution information recording unit 230, and identifies play initiation dates and times and play end dates and times of the friends for the past 10 weeks. The play date and time identification unit 212 refers to play dates and times for the past 10 weeks and identifies the time periods in which each of the plurality of friends played the game during the past 10 weeks.

The play probability derivation unit 214 derives a probability that each of the plurality of friends of the user A will play the game in a plurality of time periods in the future. The play probability derivation unit 214 derives play probabilities for a plurality of time periods in the coming week from play dates and times for the past 10 weeks.

The time period identification unit 216 identifies a time period in the future in which there are many friends having high probabilities of playing the game. For example, the time period identification unit 216 may identify the time periods with the most, time periods with the second most, and time periods with the third most friends having high probabilities of playing the game. It is assumed that the identified time period in the future is a time period in which the probability of the user A serving as the host user playing is high. Therefore, the time period identification unit 216 does not identify time periods in which the play probability of the user A is less than 70%, but identifies a time period in the future in which the play probability of the user A is 70% or more and in which there are many friends having high probabilities of playing the game.

The notification unit 218 notifies the user A of the information indicating the identified time period in the future and information on the users having high probabilities of playing the game in the time period. The information indicating the time periods is information that identifies dates and time periods. In the present example, information indicating the time periods with the first to third most friends having high probabilities of playing the game is notified.

In the information processing device 10, the event information acquisition unit 118 acquires information indicating the time period in the future and information on friends having high probabilities of playing the game in the time period. The friends notified by the server device 5 are those who have been determined to have a 70% or higher probability of playing during the time period, so the host user can expect that many of the notified users will participate in the game tournament. The input screen generation unit 120 generates an input screen indicating the acquired time period in the future and the number of the users having high probabilities of playing during the time period, and the display processing unit 124 displays the input screen on the output device 4.

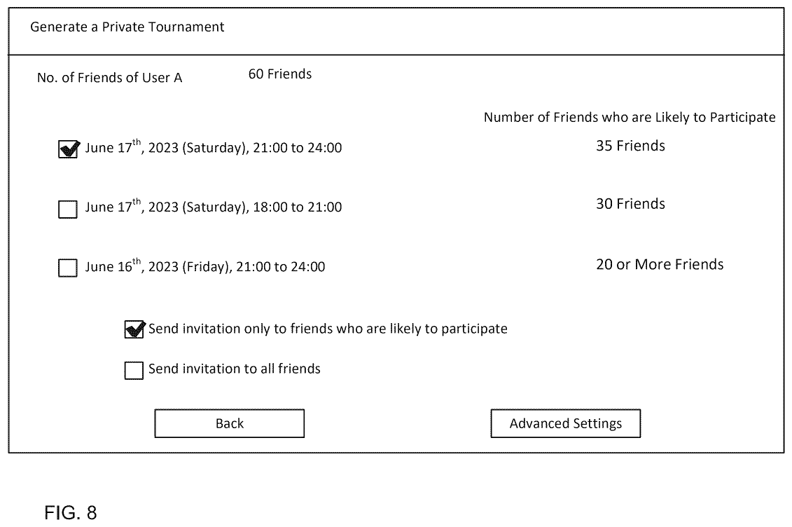

FIG. 8 illustrates an example of a settings screen for a private tournament. The display processing unit 124 displays three time periods as candidate dates and times for the event in descending order of the number of friends having high probabilities of playing the game, that is, friends having high probabilities of participating in the game tournament. The user A may select one of the three candidate time periods, and in the present example, the user A selects the time period “Jun. 17, 2023 (Saturday), 21:00 to 24:00”.

The input screen indicates that the user A has 60 friends, and also indicates the number of friends who are likely to participate in each candidate time period. In the present example, the number of friends who are likely to participate on “Jun. 17, 2023 (Saturday), 21:00 to 24:00” is displayed as “35 people,” and the number of friends who are likely to participate on “Jun. 17, 2023 (Saturday), 18:00 to 21:00” is displayed as “30 people.” On the other hand, the number of friends who are likely to participate on “Jun. 16, 2023 (Friday), 21:00 to 24:00” is displayed as “20 people or more”. In other words, the first two display the exact number of friends, but for the time period “Jun. 16, 2023 (Friday), 21:00 to 24:00”, the number of people displayed is a bit vague, at “20 people or more”.

In the information processing system 1 according to the embodiment, each user may set privacy settings to determine whether or not personal information such as past play dates and times and future play plans are made public to other users. Therefore, it is desirable to avoid a situation in which the past play dates and times and future play plans of a user who has elected not to make the information public are leaked to the user A. Therefore, when friends who have set their personal information to private in the privacy settings are included among the friends who are likely to participate, the display processing unit 124 may display a range of the number of friends including an exact number of friends without displaying the exact number of friends. In the example illustrated in FIG. 8, the number of friends likely to participate during the time period “Jun. 16, 2023 (Friday), 21:00 to 24:00” is actually “23 people”. However, because friends who have set their personal information to private are included therein, the number of friends is displayed as “20 people or more” to avoid displaying the exact number of friends, and a number close to the exact number of friends is displayed.

Furthermore, when the exact number of friends is displayed when there are only a few friends who have set their personal information to private among those who are likely to participate, a situation arises in which the friends who have set their personal information to private are easily identified, increasing the possibility that the personal information of private users will be leaked to the user A. On the other hand, when there are a large number of friends who have set their personal information to private among those who are likely to participate, the possibility of the personal information of private users being leaked to the user A becomes significantly lower. Therefore, when there are many friends who have set their personal information to private, the exact number may be displayed, and when there are few friends who have set their personal information to private, the exact number may be avoided and a range including the exact number of friends may be displayed. For example, when there is a predetermined number (for example, 10) or more of friends who are set to private, the display processing unit 124 may display the exact number of friends.

When the user A moves the cursor to focus on a candidate time period, a list of friends who are likely to participate in that candidate time slot is displayed.

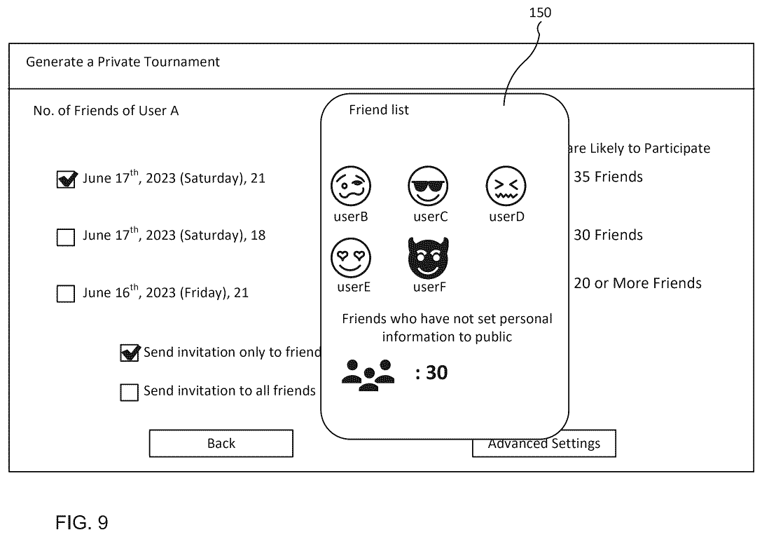

FIG. 9 illustrates an example of a friend list 150. Here, the friend list 150 that is displayed when the user A places the cursor on the time period “Jun. 17, 2023 (Saturday), 21:00 to 24:00” is shown. The friend list 150 displays information about 35 friends who are most likely to participate.

In the present example, five friends have elected to set their personal information to public in the privacy settings, and user names (a user B to a user F) are displayed along with icons. The user A may access the page of a user who has set their personal information to public and view the personal information such as past play dates and times and future play plans. On the other hand, 30 friends have set their personal information to private in the privacy settings, and the icons and user names are not displayed in the friend list.

Returning to FIG. 8, the user A selects who to invite to the game tournament. On this screen, “Send invitation only to friends who are likely to participate” is selected by default, and thus invitations will be sent to 35 friends who are likely to participate in the game tournament to be held on Jun. 17, 2023 (Saturday), 21:00 to 24:00. When the user A wants to send an invitation to all of his or her friends, the user A selects “Send invitation to all friends”. In any case, the user A may invite at least friends having high probabilities of playing the game on “Jun. 17, 2023 (Saturday), 21:00 to 24:00” (those who are likely to participate in the game tournament), using the input screen illustrated in FIG. 8.

When the user A selects the “advanced settings” button, the input screen generation unit 120 generates an advanced settings screen, and the display processing unit 124 displays the advanced settings screen on the output device 4.

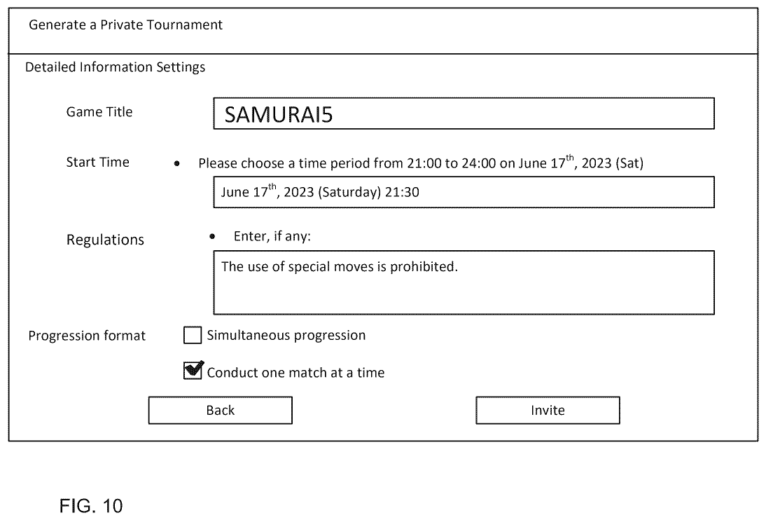

FIG. 10 illustrates an example of an advanced settings screen for a private tournament. On the advanced settings screen, the user A inputs the title of the game to be played in the game tournament. In the present example, the title “SAMURAI5” is entered. Note that when the game program has a private tournament contact function and the user A starts SAMURAI5 to generate a private tournament, a SAMURAI5 tournament will be held, so there is no input field for the game title.

The user A inputs the time at which the tournament will start within the selected time period. In the present example, the start time of the tournament is entered as “21: 30” within the time period “Jun. 17, 2023 (Saturday), 21:00 to 24:00”.

The user A may input the regulations of the tournament. When the game provides regulation parameters, the user A may set the regulations by selecting the parameters. When such parameters are not provided, the user A may enter the regulation in text. For example, the user A may enter regulations such as, “The use of special moves is prohibited”.

The user A may select the format in which the tournament will proceed. In a typical tournament format, matches are held simultaneously in order to efficiently conduct the matches. However, since the private tournament according to the embodiment is premised on matches between friends, it is conceivable that participants may wish to watch each match. Therefore, two options for the progression format are provided: “simultaneous progression” and “conduct one match at a time”, allowing the user A to freely decide the progression format. The user A may select “simultaneous progression” when the number of participants is likely to be large, or “conduct one match at a time”when the number of participants is likely to be small.

When the user A selects the “Invite” button, the invitation unit 122 invites the selected friends. Specifically, the invitation unit 122 notifies the server device 5 of the designated time period, the friends to be invited, and the detailed information entered on the advanced settings screen, and the invitation message transmission unit 224 generates an invitation message including detailed information on the tournament and sends such to a plurality of the user A's friends. The friends to whom the invitation message is transmitted include at least friends having high probabilities of playing on “Jun. 17, 2023 (Saturday), 21:00 to 24:00”.

The information processing device 10 of the user A accepts the participation of friends. When the participation acceptance deadline arrives, the information processing device 10 creates a tournament-style match schedule and provides such to participating friends. Note that the server device 5 may also accept the participation of friends and create a match schedule. Tournament participants including the user A gather at the start date and time to conduct the game tournament.

As described above, in the information processing system 1 according to the embodiment, the server device 5 is capable of effectively supporting a host user in determining a start date and time of the event by identifying a time period in the future when friends are likely to participate.

The above is a description of the present disclosure based on the embodiment. The present embodiment is an example, and it is understood by those having ordinary skill in the art that various variations are possible in the combination of their respective constituent elements and respective processing processes, and that such variations are also within the scope of the present disclosure. In the game tournament, rewards may be awarded to top performers.

In the embodiment, a range of users who may participate in the tournament is limited to friends of the host user, but the range may be expanded. For example, the range of users who may participate in the tournament may be expanded to include friends of friends. Friends may also be given the authority to forward invitation messages, so that friends who receive an invitation message are able to forward the invitation message to their own friends.

The host user may also be able to establish any group and designate the group that will participate in the event. In this case, in the information processing device 10, the group generation unit 116 generates a group including a plurality of friends in response to an instruction from the user A. The user A generates groups according to his or her purpose, such as a group of friends who are good at fighting games or a group of friends who are good at sports games. In the server device 5, the group registration unit 220 registers the group generated by the user A. When generating a private tournament, the user A designates one group from among a plurality of groups. The user A may designate one of the previously generated groups when selecting the “Generate a private tournament” menu item. The server device 5 receives a private tournament generation request along with a group designation from the user A, and the friend identification unit 222 identifies the friends included in the designated group. As a result, the play probability derivation unit 214 derives the probability that each of the plurality of friends included in the designated group will play the game in a plurality of time periods in the future, and the time period identification unit 216 identifies the time period in the future in which there are many friends having high probabilities of playing the game. Thus, the event information acquisition unit 118 in the information processing device 10 is able to acquire information on friends having high probabilities of playing the game in the time period in the future, among the friends included in the designated group.

Furthermore, the play probability derivation unit 214 derives the play probability in the time period in the future for friends who own the game to be played in the tournament, but does not need to derive the play probability in the time period in the future for friends who do not own the game. In this case, the user A is required to inform the server device 5 of the title of the game to be played in the tournament prior to the play probability derivation unit 214 deriving the play probability. Therefore, the user A may designate a game to be played at the tournament when selecting the “Generate a private tournament” menu item. This allows the play probability derivation unit 214 to derive the play probability for the time period in the future only for friends who own the game (SAMURAI5), and the event information acquisition unit 118 to acquire only information on users who own the game (SAMURAI5) that will be played at the tournament.

Furthermore, the play probability derivation unit 214 derives the play probability in the time period in the future for friends who have gaming skills equivalent to those of the user A, and does not need to derive the play probability in the time period in the future for friends who have gaming skills that differ from those of the user A.

Furthermore, when identifying the play date and time, the play date and time identification unit 212 may take into consideration whether the game is being played in a tournament. For example, when a SAMURAI 5 tournament is held, the play date and time identification unit 212 may identify only the dates and times when friends played SAMURAI 5, and not the dates and times when other games were played.

The invitation message transmission unit 224 may create a match schedule and attach such to the invitation message. In this case, the invitation message transmission unit 224 may create a tournament-style match schedule when the number of friends sending invitation messages is large, and may create a round-robin style match schedule when the number of friends sending invitation messages is small.

### INDUSTRIAL APPLICABILITY

The present disclosure may be used in art for conducting events such as game tournaments.

DESCRIPTION OF REFERENCE NUMERALS

1 . . . Information processing system, 5 . . . Server device, 10 . . . Information processing
device, 100 . . . Processing unit, 102 . . . Communication unit, 108 . . . Receiving unit, 110 . . . Game
execution unit, 112 . . . Execution information acquisition unit, 114 . . . Game image generation unit,
116 . . . Group generation unit, 118 . . . Event information acquisition unit, 120 . . . Input screen
generation unit, 122 . . . Invitation unit, 124 . . . Display processing unit, 126 . . . Transmission
processing unit, 200 . . . Processing unit, 202 . . . Communication unit, 210 . . . Execution information
acquisition unit, 212 . . . Play date and time identification unit, 214 . . . Play probability derivation
unit, 216 . . . Time period identification unit, 218 . . . Notification unit, 220 . . . Group registration unit,
222 . . . Friend identification unit, 224 . . . Invitation message transmission unit, 230 . . . Execution
information recording unit, 232 . . . Play probability recording unit.

What is claimed is:

1. A server device comprising:
one or more processors having hardware,
wherein the one or more processors are configured to:
acquire game start information indicating that a plurality of users have started a game;
acquire game end information indicating that the plurality of users have ended the game;
derive a probability that each of the plurality of users will play the game in a plurality of time periods in a future using the game start information and the game end information in a past of the plurality of users;
identify a time period in the future in which there are many users having high probabilities of playing the game; and
notify a user who will act as a host of information indicating the identified time period in the future and information on the users having high probabilities of playing the game in the time period.

2. The server device according to claim 1, wherein the one or more processors are configured to:
register a group including the plurality of users;
receive a designation of the group by the host; and
derive a probability that each of the plurality of users included in the group designated by the host will play the game in the plurality of time periods in the future.

3. The server device according to claim 1, wherein the one or more processors are configured to identify a time period in the future having a maximum number of users whose probabilities of playing the game are equal to or greater than a predetermined value.

4. An information processing device comprising:
one or more processors having hardware, wherein the one or more processors are configured to:
acquire information indicating a time period in a future and information on users having high probabilities of playing a game in the time period;
display the acquired time period in the future and a number of the users having high probabilities of playing the game in the time period; and
invite at least the users having high probabilities of playing the game to events to be held during the time period in the future.

5. The information processing device according to claim 4, wherein the one or more processors are configured to display a range of a number of users including an exact number of users having high probabilities of playing the game without displaying the exact number when the users having high probabilities of playing the game includes users who have set personal information to private in privacy settings.

6. The information processing device according to claim 4, wherein the one or more processors are configured to:
designate a group including the plurality of users; and
obtain information on users having high probabilities of playing the game in a time period in the future, among the users included in the designated group.

7. The information processing device according to claim 4, wherein the one or more processors are configured to obtain information on users who own a game to be played.

8. An event invitation method comprising:
acquiring information indicating a time period in a future and information on users having high probabilities of playing a game in the time period;
displaying the acquired time period in the future and a number of the users having the high probabilities of playing the game in the time period; and
inviting at least the users having high probabilities of playing the game to events to be held during the time period in the future.
